(19) United States
(12) Patent Application Publication
(10) Pub. No.: US 2011/0126919 A1
(43) Pub. Date: Jun. 2, 2011

(54) THERMOSTATIC HOUSING CONTROL ASSEMBLY

(76) Inventors: Zuhair A. Izzy, Carmel, IN (US); Scott K. Jones, Westfield, IN (US)

(21) Appl. No.: 12/628,668

(22) Filed: Dec. 1, 2009

(51) Int. Cl. F16K 17/38; F16K 11/22

(52) U.S. Cl. 137/468; 137/606

(57) ABSTRACT

A valve assembly including a valve housing defining a chamber, a thermostatic valve cartridge received within the chamber, a hot water flow control valve and a cold water flow control valve.

### BACKGROUND AND SUMMARY OF THE INVENTION

The present invention relates generally to valves and, more particularly, to a thermostatic valve assembly.

It is known to provide thermostatic mixing valves in connection with bathroom fixtures, such as shower heads, in order to provide scald protection by limiting and regulating the maximum outlet mixed water temperature, typically to 120 degrees Fahrenheit (48.8 degrees Celsius) or less. Such thermostatic mixing valves are often installed within vertical walls or tub/shower installations, under sink decks for kitchen and lavatory applications, and below tub decks for deck mounted roman tub faucets. Conventional thermostatic valves have typically included relatively large cast valve bodies often requiring significant spacing between other faucet components and presenting certain installation challenges.

According to an illustrative embodiment of the present disclosure, a valve fitting includes a valve housing having a cylindrical sidewall defining a chamber configured to receive a valve cartridge and defining a longitudinal housing axis extending between an inner wall and an outer open end. A center plane is defined by the longitudinal housing axis. A first inlet includes a first inlet bore having a longitudinal first inlet axis extending perpendicular to the longitudinal housing axis, the first inlet being disposed on a first side of the center plane. A second inlet includes a second inlet bore having a longitudinal second inlet axis extending perpendicular to the longitudinal housing axis. The second inlet is disposed on a second side of the center plane opposite the first inlet, and the longitudinal second inlet axis is coaxial with the longitudinal first inlet axis. A first flow control chamber extends perpendicular to the first inlet and is configured to receive a first flow control valve. A second flow control chamber extends perpendicular to the second inlet and is configured to receive a second flow control valve. A first port is in fluid communication with the chamber of the valve housing and is disposed on the first side of the center plane. A second port is in fluid communication with the chamber of the valve housing and is disposed on the second side of the center plane. The second port is spaced from the first port in the direction of the longitudinal housing axis. A first connecting passageway fluidly couples the first flow control chamber with the first port. A second connecting passageway fluidly couples the second flow control chamber with the second port. An outlet includes an outlet bore having a longitudinal outlet axis and is in fluid communication with the chamber of the valve housing.

According to a further illustrative embodiment of the present disclosure, a valve assembly includes a valve housing having a sidewall defining a chamber having a longitudinal housing axis. A thermostatic valve cartridge is received within the chamber. The thermostatic valve cartridge includes a hot water intake, a cold water intake, a mixed water outlet, and a thermostatic engine configured to adjust water flow from the mixed water outlet in response to temperature changes of mixed water supplied to the mixed water outlet. A hot water inlet includes a hot water inlet bore having a hot water inlet axis. A cold water inlet includes a cold water inlet bore having a cold water inlet axis. A hot water outer housing defines a hot water flow control chamber fluidly coupled intermediate the hot water inlet and the chamber of the valve housing. A cold water outer housing defines a cold water flow control chamber fluidly coupled intermediate the cold water inlet and the chamber of the valve housing. A hot water flow control valve includes a hot water inner housing having opposing inner and outer ends. The hot water inner housing is threadably received within the hot water flow control chamber. A stem is threadably received within the outer end of the hot water inner housing and a check valve is received within the inner end of the hot water inner housing. A cold water flow control valve includes a cold water inner housing having opposing inner and outer ends. The cold water inner housing is threadably received within the cold water flow control chamber. A stem is threadably received within the outer end of the cold water inner housing and a check valve is received within the inner end of the cold water inner housing. A hot water port is in fluid communication with the hot water intake of the thermostatic valve cartridge. A cold water port is in fluid communication with the cold water intake of the thermostatic valve cartridge, the cold water port being axially spaced relative to the hot water port. An outlet includes an outlet bore in fluid communication with the mixed water outlet of the thermostatic valve cartridge.

According to another illustrative embodiment of the present disclosure, a valve assembly includes a valve housing having a sidewall defining a chamber having a longitudinal housing axis. A thermostatic valve cartridge is received within the chamber and includes a hot water intake, a cold water intake, a mixed water outlet, and a thermostatic engine configured to adjust water flow to the mixed water outlet. A hot water inlet includes a hot water inlet bore having a hot water inlet axis. A cold water inlet includes a cold water inlet bore having a cold water inlet axis. A hot water outer housing defines a hot water flow control chamber fluidly coupled intermediate the hot water inlet and the chamber of the valve housing. A cold water outer housing defines a cold water flow control chamber fluidly coupled intermediate the cold water inlet and the chamber of the valve housing. A hot water flow control valve includes a hot water inner housing having opposing first and second ends. The hot water inner housing is threadably received within the hot water flow control chamber. A stem is threadably received within the first end of the hot water outer housing. A cold water flow control valve includes a cold water inner housing having opposing first and second ends. The cold water inner housing is threadably received within the cold water flow control chamber. A stem is threadably received within the first end of the cold water inner housing. A hot water port is in fluid communication with the hot water intake of the thermostatic valve cartridge. A cold water port is in fluid communication with the cold water intake of the thermostatic valve cartridge, the cold water port being axially spaced relative to the hot water port. An outlet includes an outlet bore in fluid communication with the chamber of the valve housing. A sleeve receives an upper portion of the valve cartridge and is supported by the chamber of the valve housing. A temperature limit stop is supported by an outer end of the sleeve. A resilient clip couples the temperature limit stop to the sleeve. A cooperating stop is configured to rotate with the valve stem and engage with the temperature limit stop to restrict rotation therebetween.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of an illustrative embodiment thermostatic mixing valve assembly of the present disclosure;

FIG. 2 is a front exploded perspective view of the thermostatic mixing valve assembly of FIG. 1;

FIG. 3 is a rear exploded perspective view of the thermostatic valve assembly of FIG. 1;

FIG. 4 is a cross-sectional view taken along line 4-4 of FIG. 1;

FIG. 5 is cross-sectional view similar to FIG. 4, showing the thermostatic valve cartridge in elevation, and with the hot water stop and the cold water stop in closed positions;

FIG. 6 is a partial exploded perspective view of the thermostatic mixing valve assembly of FIG. 1, showing the thermostatic valve cartridge removed from the valve fitting;

FIG. 7 is a cross-sectional view of the valve fitting of FIG. 4;

FIG. 8 is a cross-sectional view taken along line 8-8 of FIG. 6;

FIG. 9 is an exploded perspective view of the sleeve assembly and cooperating handle assembly;

FIG. 10 is a perspective view showing the valve assembly and cooperating temperature limit stop; and

FIG. 11 is a exploded perspective view showing a valve fitting and plug for rough installation.

### DETAILED DESCRIPTION OF THE DRAWINGS

The embodiments of the invention described herein are not intended to be exhaustive or to limit the invention to precise forms disclosed. Rather, the embodiment selected for description have been chosen to enable one skilled in the art to practice the invention.

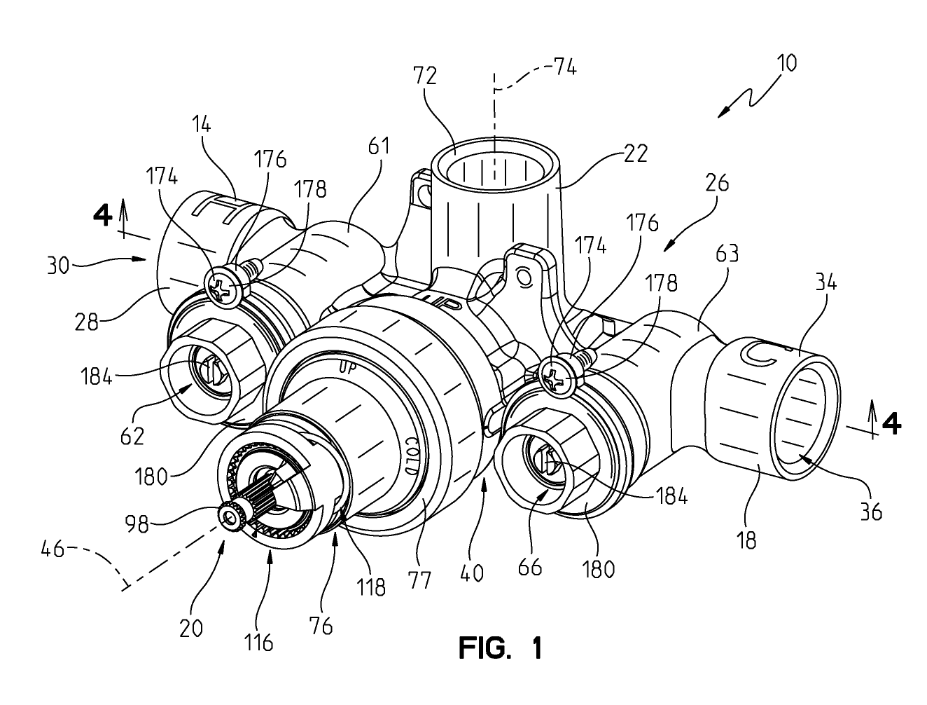

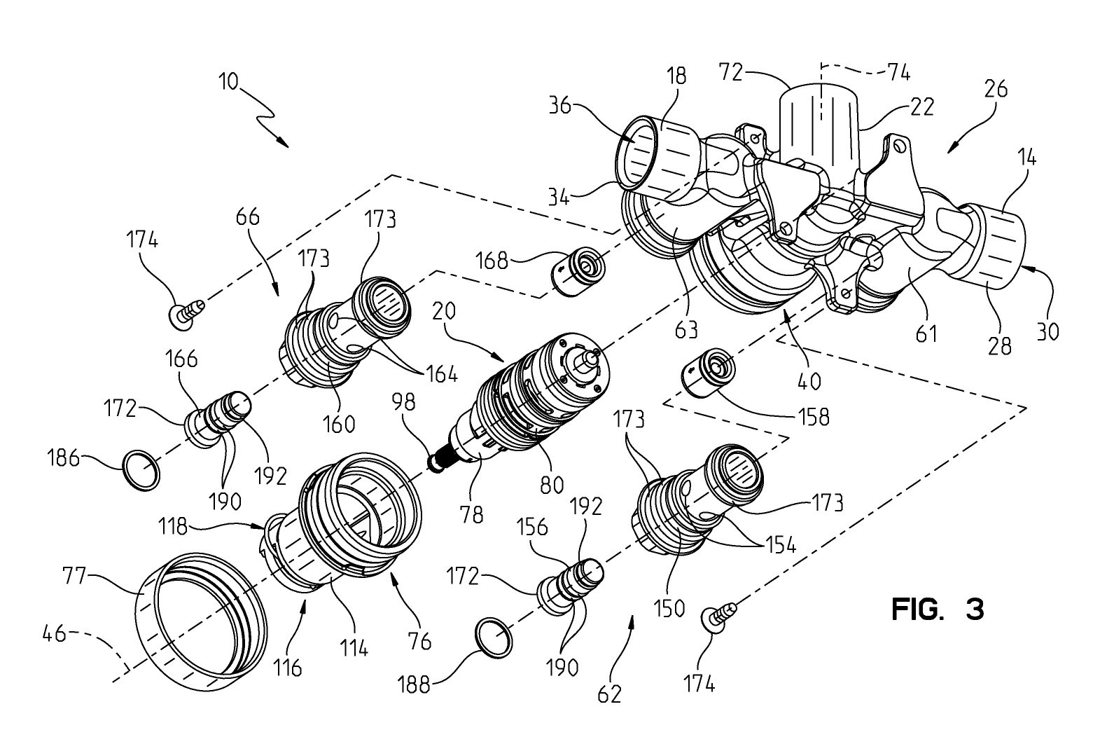

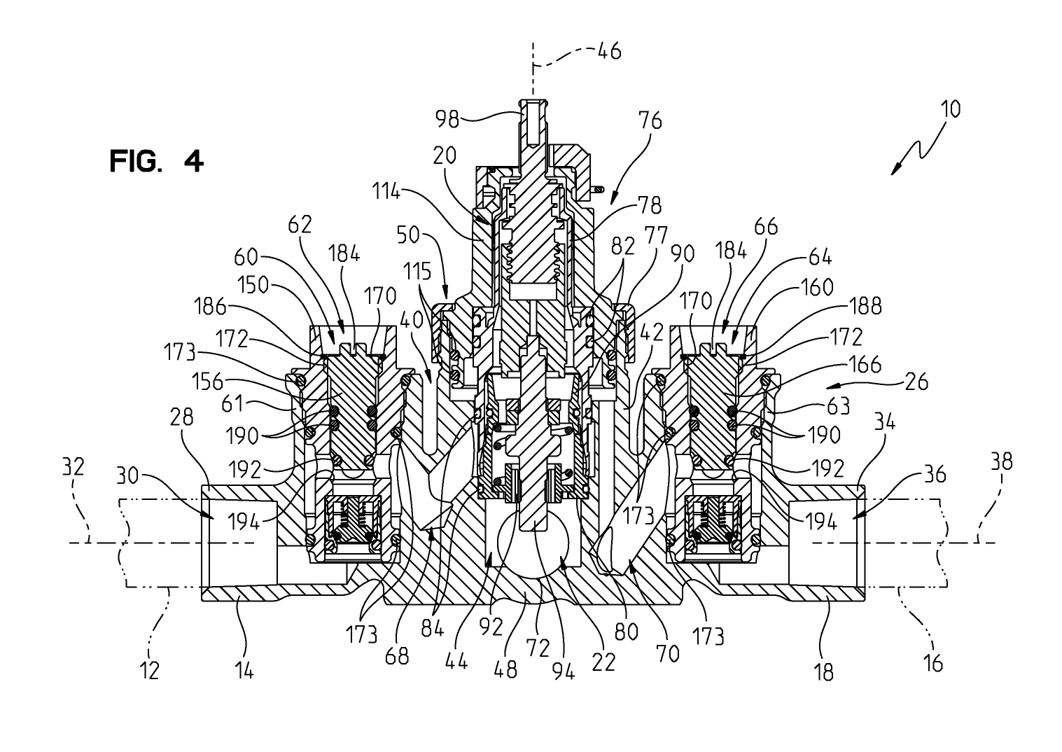

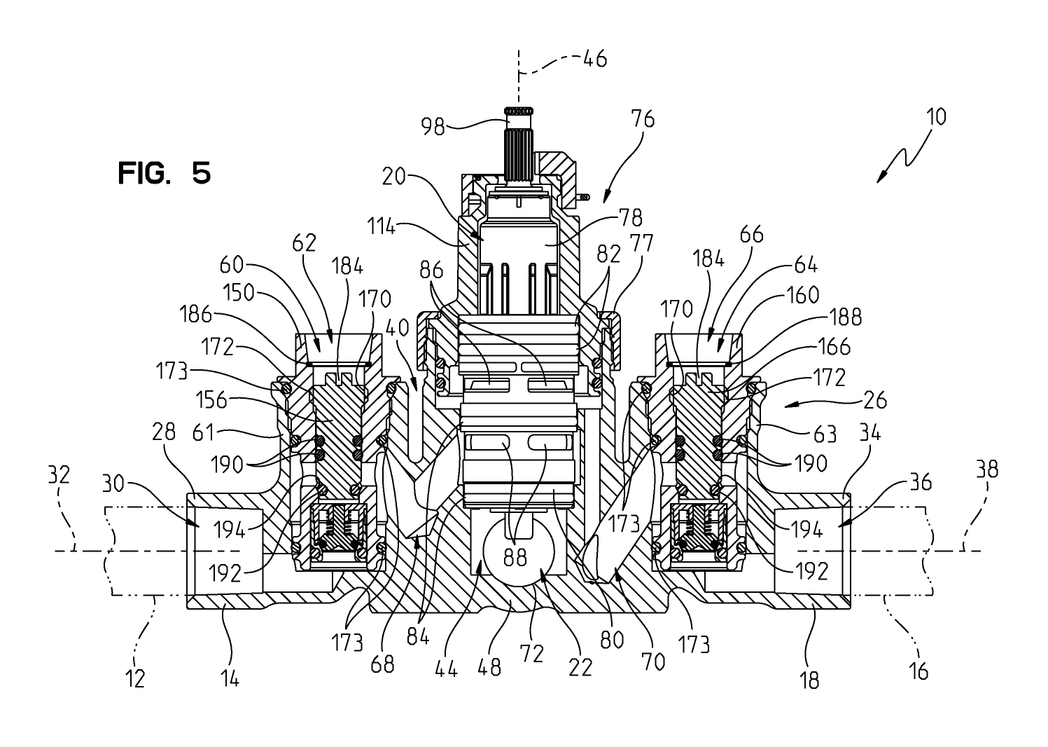

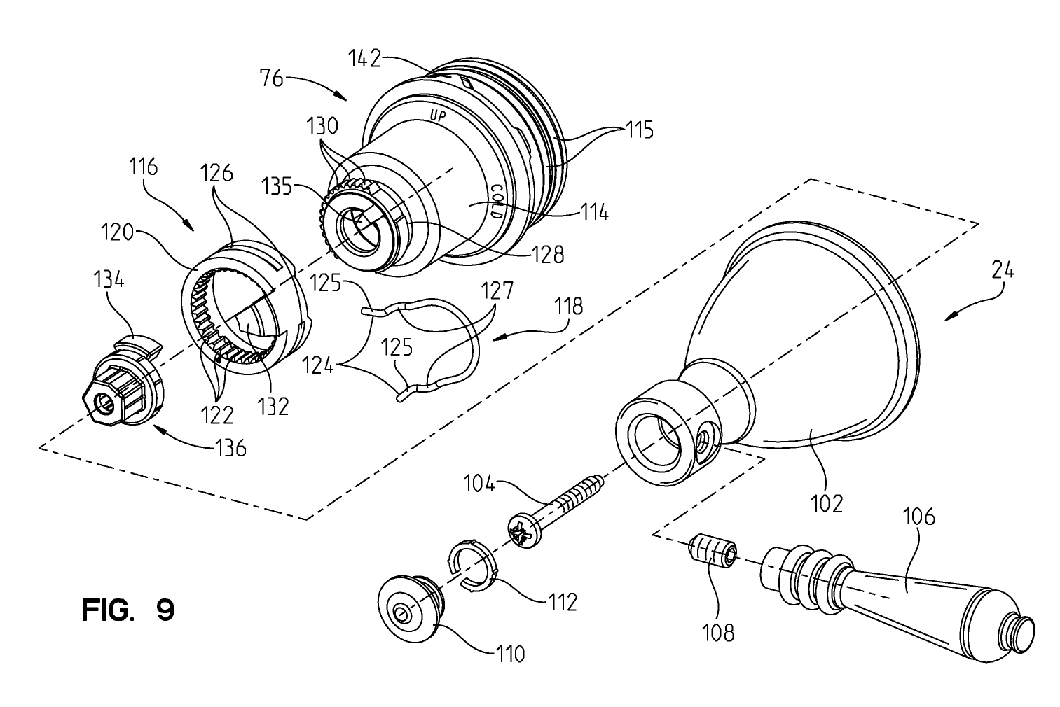

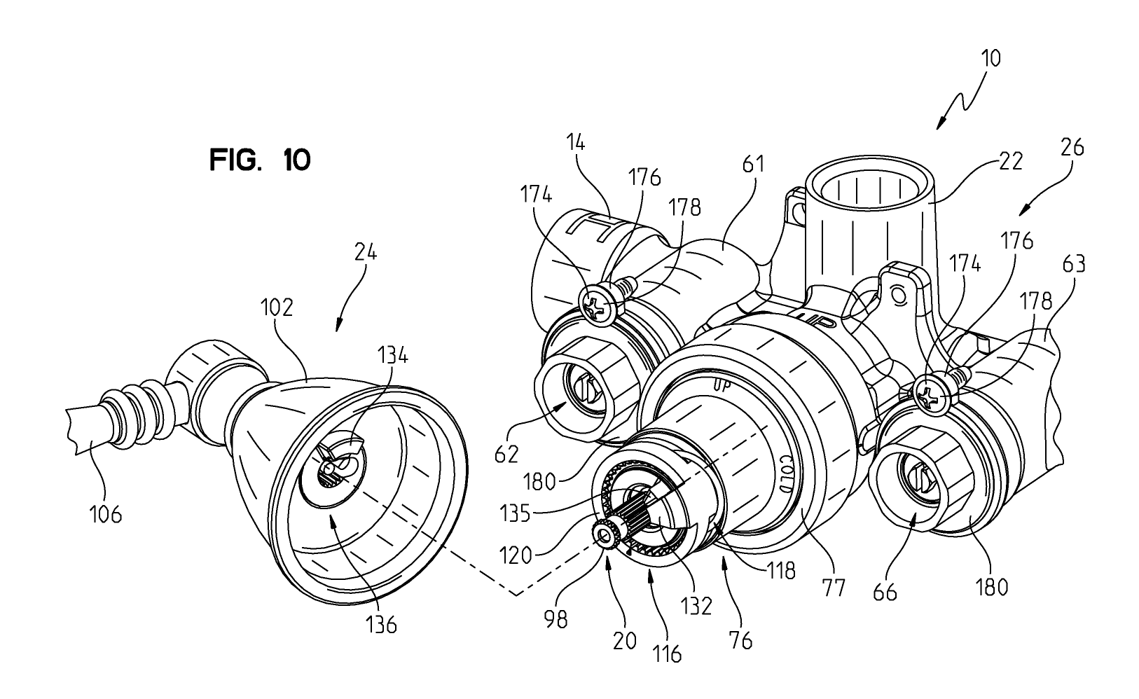

Referring initially to FIGS. 1-4, a thermostatic valve assembly 10 of the present disclosure may be used to supply water to a fluid delivery device. In one illustrative embodiment, the valve assembly 10 is configured to be fluidly coupled to a conventional shower head through a shower riser (not shown). In such an installation, a hot water supply line 12 couples to a first or hot water inlet 14, and a cold water supply line 16 fluidly couples to a second or cold water inlet 18 (FIGS. 4 and 5). Water from the hot water inlet 14 and the cold water inlet 18 is mixed within a thermostatic valve cartridge 20 and supplied to a mixed water outlet 22. Temperature of the mixed water is illustratively controlled by a user temperature control input, such as a handle assembly 24 (FIGS. 9 and 10). Volume or flow control of the mixed water may be accomplished by a downstream user flow control input (not shown).

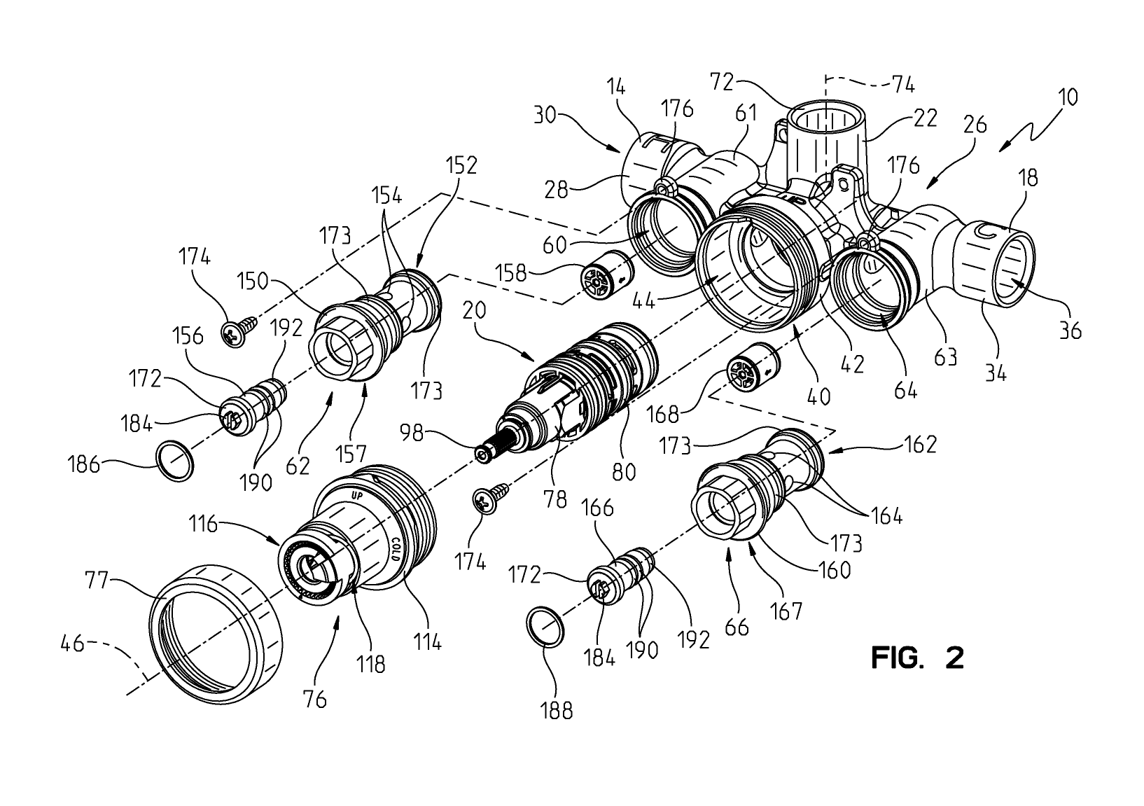

Referring further to FIGS. 2-5, the thermostatic valve assembly 10 includes a valve fitting 26 defining the hot water inlet 14 and the cold water inlet 18. Illustratively, the valve fitting 26 is forged from brass and subsequently machined. The hot water inlet 14 includes a tubular body 28 defining a first or hot water inlet bore 30 having a longitudinal hot water inlet axis 32. Similarly, the cold water inlet 18 includes a tubular body 34 defining a cold water inlet bore 36 having a longitudinal cold water inlet axis 38. In the illustrative embodiment, the cold water inlet axis 38 is coaxially aligned with the hot water inlet axis 32.

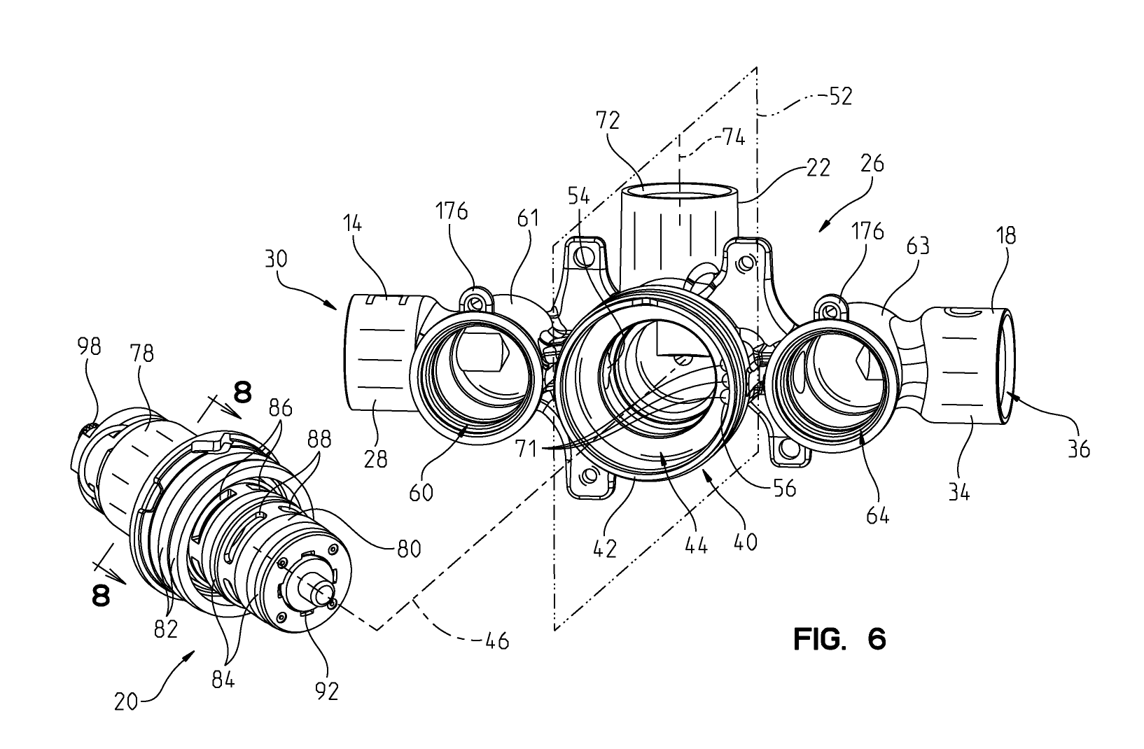

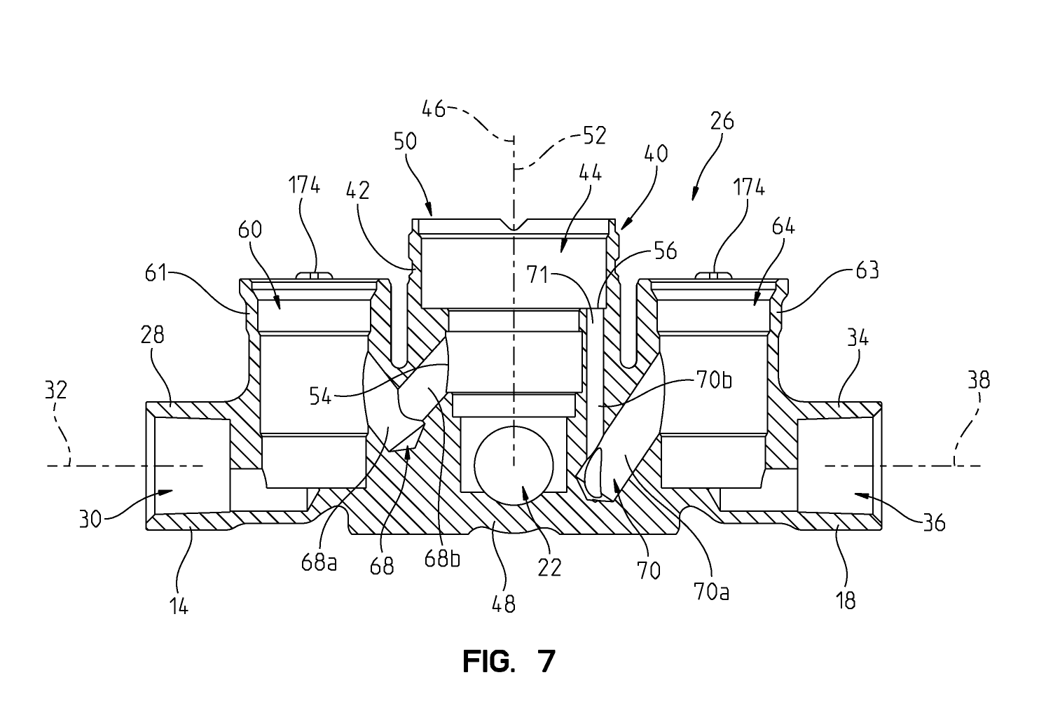

With reference to FIGS. 6 and 7, the valve fitting 26 further includes a mixing valve housing 40 having a cylindrical sidewall 42 defining a cavity or chamber 44 extending along a longitudinal housing axis 46 between an inner or end wall 48 and an open end 50. The longitudinal housing axis 46 defines a center plane 52 extending between the hot water inlet 14 and the cold water inlet 18. A first or hot water supply port 54 extends through the sidewall 42 and is in fluid communication with the chamber 44. Similarly, a second or cold water supply port 56 extends through the sidewall 42 and is in fluid communication with the chamber 44. The hot water supply port 54 is disposed on a first side of the center plane 52, while the cold water supply port 56 is spaced from the hot water supply port 54 on a second side of the center plane 52. Further, the cold water supply port 56 is spaced from the hot water supply port 54 in the direction of a longitudinal housing axis 46. More particularly, as shown in FIG. 7, the hot water supply port 54 is illustratively positioned longitudinally inwardly from the cold water supply port 56.

A first or hot water flow control chamber 60 extends perpendicular to the hot water inlet 14 and is defined by a first or hot water outer housing 61. A first or hot water flow control valve, illustratively a stop valve 62, is received within the flow control chamber 60. Similarly, a second or cold water flow control chamber 64 extends perpendicular to the cold water inlet 18 and is defined by a second or cold water outer housing 63. A second or cold water flow control valve, illustratively a stop valve 66, is received within the flow control chamber 64.

A first connecting passageway 68 fluidly couples the hot water flow control chamber 60 with the hot water supply port 54. Similarly, a second connecting passageway 70 fluidly couples the cold water flow control chamber 64 with the cold water supply port 56. The first connecting passageway 68 has a generally V-shaped cross-section defined by an inwardly extending portion 68a coupled to the control chamber 60, and an outwardly extending portion 68b coupled to the supply port 54. The second connecting passageway 70 also has a generally V-shaped cross-section defined by an inwardly extending portion 70a coupled to the flow chamber 64, and an outwardly extending portion 70b coupled to the supply port 56. The outwardly extending portion 70b of the second connecting passageway 70 illustratively includes a plurality of conduits 71 within the sidewall 42 of the valve housing 40 (FIG. 6). The conduits 71 extend parallel to the longitudinal housing axis 46 and intersect at an acute angle the inwardly extending portion 70a of the second connecting passageway 70. The mixed water outlet 22 includes an outlet bore 72 in fluid communication with the chamber 44 of the valve housing 40 and includes a longitudinal outlet axis 74 extending perpendicular to the longitudinal housing axis 46.

With reference to FIG. 1, the valve fitting 26 may include markings to help the installer identify proper orientation and water connections. For example, the valve fitting 26 may include the marking “H” on the hot water inlet 14 to indicate connection of the hot water supply line 12, the marking “C” on the cold water inlet 18 to indicate connection of the cold water supply line 16, and the marking “UP” on the valve housing 40 to indicate mounting orientation of the valve assembly 10.

As further detailed herein, the hot water stop valve 62 is configured to control fluid communication between the bore 30 of the hot water inlet 14 and the hot water supply port 54. Similarly, the cold water stop valve 66 is configured to control fluid communication between the bore 36 of the cold water inlet 18 and the cold water supply port 56.

A sleeve assembly 76 and a bonnet nut 77 illustratively secure the valve cartridge 20 within the valve housing 40. The chamber 44 of the valve housing 40 is configured to support the thermostatic valve cartridge 20. The thermostatic valve cartridge 20 may be of conventional design and illustratively comprises a thermostatic valve cartridge similar to Model No. CA18-01 available from Vernet S.A. of Ollainville, France.

With further reference to FIGS. 2-6, the thermostatic valve cartridge 20 illustratively includes a hollow outer envelope or housing 78 having a generally cylindrical shape extending axially along the longitudinal housing axis 46. A flow receiving portion 80 of the cartridge housing 78 is received within the valve housing 40. As shown in FIGS. 4-6, a plurality of o-rings 82 and 84 are supported by the cartridge housing 78. First or outer radial openings 86, and second or inner radial openings 88 are formed within the flow receiving portion 80 of the cartridge housing 78. Illustratively, the cartridge housing 78 includes two series of four circumferentially spaced arc-shaped openings 86 and 88, the two series being longitudinally spaced apart from each other. The outer radial openings 86 are configured to receive cold water supplied by the cold water inlet 18, while the inner radial openings 88 are configured to receive hot water supplied by the hot water inlet 14. Each of the openings 86 and 88 may be provided with a filter, for example, perforated stainless steel strips (not shown).

With reference to FIG. 4, a slide 90 is supported for movement within the housing 78 of the thermostatic valve cartridge 20. More particularly, the slide 90 may be moved for adjusting the temperature of the mixture of cold and hot water by varying the flow cross-sections of cold and hot water passing through the openings 86 and 88, respectively. The mixed water exits the cartridge housing 78 through an outlet 92.

An expandable thermostatic element or engine 94 is operably coupled to the slide 90. The thermostatic element 94 illustratively includes an expandable wax that urges the slide to move in response to temperature changes of the mixed water supplied to the outlet 92. More particularly, an increase in mixed water temperature above a predetermined value will cause the thermostatic element 94 to adjust or move, thereby moving the slide 90 in the direction reducing the cross-sectional flow path of the hot water openings 88. The thermostatic element 94 will close the hot water openings 88 when the temperature of the mixed water supplied to the outlet exceeds a predetermined temperature (illustratively 120 degrees Fahrenheit (48.89 degrees Celsius)). In a similar manner, a decrease in the mixed water temperature below a predetermined value will cause the thermostatic element 94 to urge the slide 90 in a direction reducing the cross-sectional flow path of the cold water openings 86. As such, the thermostatic valve cartridge 20 is configured to provide high temperature and low temperature limits through the outlet 92 and a downstream shower riser (not shown).

A control stem 98 is operably coupled to an adjustment member 100, such that rotation of the control stem 98 causes axial movement of the adjustment member 100. An outer end of the adjustment member 100 is coupled the temperature control handle assembly 24 (FIG. 10), while an inner end of the adjustment member 100 is configured to cooperate with the slide 90 (FIG. 4). More particularly, rotation of the control stem 98 by the handle assembly 24 causes the adjustment member to move the slide 90, thereby altering the flow sections of water through the openings 86 and 88, and determining the temperature of the mixed water leaving the outlet 92. Additional details of illustrative thermostatic valve cartridges are provided in U.S. Pat. No. 6,085,984 and U.S. Pat. No. 6,557,770, the disclosures of which are expressly incorporated by reference herein.

With reference to FIGS. 9 and 10, the handle assembly 24 includes a base 102 secured to the control stem 98 through a fastener, such as screws 104. A handle lever 106 is secured to the base 102 through a set screw 108. A cap 110 is secured to the base 102 by a retaining clip 112 and covers the screw 104.

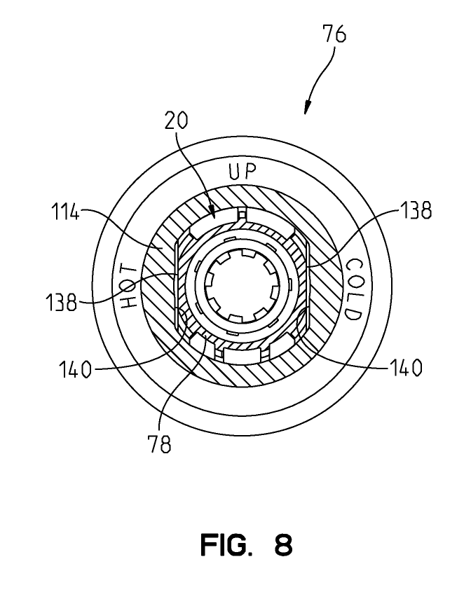

The thermostatic valve cartridge 20 is rotationally oriented by the sleeve assembly 76 including a brass sleeve 114 secured in position by the bonnet nut 77. More particularly, the sleeve 114 is conventionally received with the valve housing 40 and sealed with the sidewall 42 through o-rings 115. A temperature limit stop 116 is supported by the sleeve 114 and is secured thereto by a resilient retaining clip 118. Orientation of the cartridge 20 inside the sleeve 114 is achieved by aligning external locating flats or surfaces 138 in the cartridge housing 78 with internal locating flats or surfaces 140 in the sleeve 114 (FIG. 8). The sleeve 114 may include markings, such as “HOT”, “COLD”, and “UP”, to assist in proper orientation within the valve fitting 26.

With further reference to FIG. 9, the limit stop 116 includes an annular body 120 including a plurality of radially inwardly extending teeth 122. The resilient retaining clip 118 includes arms 124 extending through slots 126 formed in the body 120 and received within an annular groove 128 of the sleeve 114. Angled leading portions 125 facilitate insertion of the clip 118 within the annular groove 128, while arcuate retaining portions 127 facilitate retention of the clip 118 on the sleeve 114.

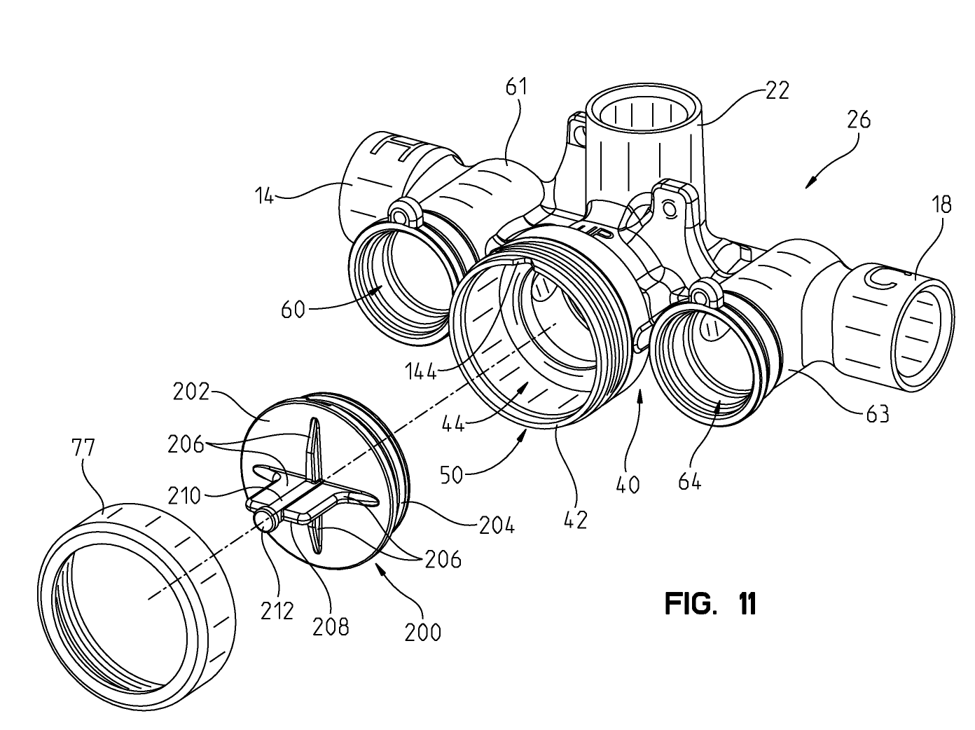

The sleeve 114 includes radially outwardly extending teeth 130 which cooperate with teeth 122 of the limit stop 116. The cooperating teeth 122 and 130 provide for a plurality of discrete rotational positions of the limit stop 116 relative to the sleeve 114. An outwardly extending protrusion 132 is supported by the body 120 and is configured to engage an inwardly extending protrusion 134 of a cooperating stop member 136 supported within base 102 of the handle assembly 24 (FIG. 10). Engagement between protrusions 132 and 134 limits rotation of the handle assembly 24 and establishes an upper (hot) temperature limit stop. Similarly, an outwardly extending protrusion 135 supported by the sleeve 114 may be configured to engage the protrusion 134 of the handle assembly 24 for provide a lower (cold) temperature limit stop. Proper installation and mounting of the sleeve 114 relative to the valve housing 40 is achieved by aligning a tab 142 in the sleeve 114 with a notch 144 in the valve fitting 26 (FIGS. 9 and 11).

Referring again to FIGS. 2-5, the hot water and cold water stop valves 62 and 66 are substantially identical. The hot water stop valve 62 illustratively includes a first or hot water inner housing 150 threadably received within the outer housing 61 of the hot water flow control chamber 60. The inner end 152 of the inner housing 150 is in fluid communication with the hot water inlet 14. A plurality of radial openings 154 are formed within the inner housing 150 and are in fluid communication with the first connecting passageway 68. A first or hot water stem 156 is threadably received within an outer end 157 of the inner housing 150, and a check valve 158 is received within the inner end 152 of the inner housing 150. Similarly, the cold water stop valve 66 illustratively includes an inner housing 160 threadably received within the outer housing 63 of the cold water flow control chamber 64. The inner end 162 of the inner housing 160 is in fluid communication with the cold water inlet 18. A plurality of radial openings 164 are formed within the inner housing 160 and are in fluid communication with the second connecting passageway 70. A second or cold water stem 166 is threadably received within the outer end 167 of the housing 160, and a check valve 168 is received within the inner end 162 of the housing 160.

Each of the outer housings 61 and 63 includes internal threads 170 which couple with external threads 172 of the respective inner housing 150 and 160. A plurality of seals, illustratively o-rings 173, are supported intermediate the inner housings 150, 160 and the outer housings 61, 63, respectively. As shown in FIG. 1, a retaining fastener, illustratively a screw 174, is threadably received within a boss 176 formed within each outer housing 61 and 63. A head 178 of each screw 174 engages an annular flange 180 of inner housing 150, 160 to assist in axially securing the inner housing 150, 160 within the outer housing 61, 63, respectively. More particularly, the screws 174 serve as secondary retainers to the threads 170, 172 for maintaining the inner housings 150, 160 within the outer housings 61, 63 in opposition to internal water pressure.

An outer end of each stem 156, 166 includes a tool engagement member, illustratively a slot 184 to receive a screwdriver blade for facilitating rotation and thereby axial movement of the stem 156, 166 within the respective inner housing 150, 160. A first retaining ring 186 is supported by the hot water inner housing 150 of the hot water flow control valve 62 and is configured to limit movement of the stem 156 axially outwardly away from the hot water inner housing 150. Similarly, a second retaining ring 188 is supported by the cold water inner housing 160 of the cold water flow control valve 66 and is configured to limit movement of the second stem 166 axially outwardly away from the cold water inner housing 160.

A pair of seals, illustratively o-rings 190, are supported by each stem 156, 166 to prevent water leakage through the outer end 157, 167 of the inner housing 150, 160, respectively. An inner end of each stem 156, 166 supports a seal, illustratively an o-ring 192, configured to selectively engage a valve seat 194. In the open positions of FIG. 4, the stems 156 and 166 permit the flow of water from the water inlets 14 and 18, through the connecting passageways 68 and 70, and to the chamber 44 through supply ports 54 and 56, respectively. By rotating the stems 156 and 166 counterclockwise, the stems 156 and 166 move axially inwardly until the o-rings 192 sealing engage with the valve seats 194 as shown in FIG. 5. In the closed position of FIG. 5, water flow from the inlets 14 and 18 through the respective stop valves 62 and 66 is prevented.

The check valves 158 and 168 are secured within the inner ends 152 and 162 of respective inner housings 150 and 160. The check valves 158 and 160 are configured to permit fluid flow only in one direction, illustratively from the hot water and cold water inlets 14 and 18 to the connecting passageways 68 and 70, respectively. As such, the check valves 158 and 160 prevent cross-flow between inlets 14 and 18 in the event of loss of fluid pressure.

FIG. 11 illustrates the valve fitting 26 in a rough installation, prior to final assembly of the thermostatic valve cartridge 20, the sleeve assembly, and the handle assembly. More particularly, a test cap 200 is configured to be sealingly received within the open end 50 of the valve housing 40. The test cap 200 may be used for testing of the plumbing system prior to final installation of the valve cartridge 20 within the valve housing 40. The test cap 200 includes a body 202 concentrically received within the chamber 44 of the valve housing 40 and sealing the open end 50 by cooperating with a conventional seal, such as an o-ring 204. A plurality of ribs 206 project upwardly from the body 202, wherein a pair of opposing ribs 206 define a handle 208 to facilitate positioning of the test cap 200 within the valve housing 40. The ribs 206 provide added strength to the test cap 200. The ribs 206 are connected through an upwardly extending connecting post 210 having an enlarged head 212. The head 212 is configured to be received within a opening formed in a cover (not shown). The test cap 200 may be formed from a molded thermoplastic.

During operation the hot water and cold water stems 156 and 166 may be rotatably adjusted within the inner housings 150 and 160 to axially move the seals 192 within the flow control chambers 60 and 64, respectively, between open and closed positions (FIGS. 4 and 5). Illustratively, a tool, such as a screwdriver (not shown) may be used to access the tool engagement member 184 at the outer end of each stem 156 and 166. By rotating each stem 156 and 166, the seal 192 moves in an axial direction within the respective flow control chamber 60 and 64 such that the seal 192 engages the respective seat 194, thereby preventing water flow through the inlet 14 and 18.

Although the invention has been described in detail with reference to certain preferred embodiments, variations and modifications exist within the spirit and scope of the invention as described and defined in the following claims.

1. A valve fitting comprising:
a valve housing including a cylindrical sidewall defining a chamber configured to receive a valve cartridge and defining a longitudinal housing axis extending between an inner wall and an outer open end, a center plane defined by the longitudinal housing axis;
a first inlet including a first inlet bore having a longitudinal first inlet axis extending perpendicular to the longitudinal housing axis, the first inlet being disposed on a first side of the center plane;
a second inlet including a second inlet bore having a longitudinal second inlet axis extending perpendicular to the longitudinal housing axis, the second inlet being disposed on a second side of the center plane opposite the first inlet, and the longitudinal second inlet axis being coaxial with the longitudinal first inlet axis;
a first flow control chamber extending perpendicular to the first inlet and configured to receive a first flow control valve;
a second flow control chamber extending perpendicular to the second inlet and configured to receive a second flow control valve;
a first port in fluid communication with the chamber of the valve housing and disposed on the first side of the center plane;
a second port in fluid communication with the chamber of the valve housing and disposed on the second side of the center plane, the second port spaced from the first port in the direction of the longitudinal housing axis;
a first connecting passageway fluidly coupling the first flow control chamber with the first port;
a second connecting passageway fluidly coupling the second flow control chamber with the second port; and
an outlet including an outlet bore having a longitudinal outlet axis is in fluid communication with the chamber of the valve housing.

2. The valve fitting of claim 1, wherein:
the first connecting passageway has a V-shaped cross-section defined by an inwardly extending portion coupled to the first flow control chamber, and an outwardly extending portion coupled to the first port; and
the second connecting passageway has a V-shaped cross-section defined by an inwardly extending portion coupled to the second flow control chamber, and an outwardly extending portion coupled to the second port.

3. The valve fitting of claim 2, wherein the outwardly extending portion of the second connecting passageway includes a plurality of conduits within the sidewall of the valve housing, extending parallel to the longitudinal housing axis, and intersecting at an acute angle the inwardly extending portion of the second connecting passageway.

4. The valve fitting of claim 1, wherein the valve cartridge includes a hot water intake in fluid communication with the first port, a cold water intake in fluid communication with the second port, a mixed water outlet in fluid communication with the outlet, and a thermostatic engine configured to adjust water flow to the outlet in response to temperature changes of the mixed fluid supplied to the mixed water outlet.

5. The valve fitting of claim 1, further comprising:
a first outer housing defining the first flow control chamber;
the first flow control valve including a first inner housing having opposing first and second ends, the first inner housing being threadably received within the first flow control chamber, and a first stem threadably received within the first inner housing;
a second outer housing defining the second flow control chamber; and
the second flow control valve including a second inner housing having opposing first and second ends, the second inner housing being threadably received within the second flow control chamber, and a second stem threadably received within the second inner housing.

6. The valve fitting of claim 5, wherein:
the first flow control valve further comprises a check valve received within a second end of the first inner housing; and the second flow control valve further comprises a check valve received within a second end of the second inner housing.

7. The valve fitting of claim 5, further comprising:
a first retaining ring supported by the first inner housing of the first flow control chamber and configured to limit movement of the first stem axially outwardly from the first end of the first inner housing; and
a second retaining ring supported by the second inner housing of the second flow control chamber and configured to limit movement of the second stem axially outwardly away from the second end of the second inner housing.

8. The valve fitting of claim 5, further comprising:
a first retaining fastener supported by the first outer housing and configured to axially secure the first inner housing within the first flow control chamber; and
a second retaining fastener supported by the second outer housing and configured to axially secure the second inner housing within the second flow control chamber.

9. The valve fitting of claim 1, further comprising:
a sleeve receiving an upper portion of the valve cartridge and received within the chamber of the valve housing;
a temperature limit stop supported by an outer end of the sleeve; and
a resilient clip coupling the temperature limit stop to the sleeve.

10. The valve fitting of claim 9, wherein:
the sleeve includes internal locating flats; and
the valve cartridge includes external locating flats configured to cooperate with the internal locating flats of the sleeve to properly orient the valve cartridge relative to the sleeve.

11. A valve assembly comprising:
a valve housing including a sidewall defining a chamber having a longitudinal housing axis; a thermostatic valve cartridge received within the chamber, the thermostatic valve cartridge including a hot water intake, a cold water intake, a mixed water outlet, and a thermostatic engine configured to adjust water flow to the mixed water outlet in response to temperature changes of mixed water supplied to the mixed water outlet;
a hot water inlet including a hot water inlet bore having a hot water inlet axis;
a cold water inlet including a cold water inlet bore having a cold water inlet axis;
a hot water outer housing defining a hot water flow control chamber fluidly coupled intermediate the hot water inlet and the chamber of the valve housing;
a cold water outer housing defining a cold water flow control chamber fluidly coupled intermediate the cold water inlet and the chamber of the valve housing;
a hot water flow control valve including a hot water inner housing having opposing inner and outer ends, the hot water inner housing threadably received within the hot water flow control chamber, a first stem threadably received within the outer end of the hot water inner housing and a check valve received within the inner end of the hot water inner housing;
a cold water flow control valve including a cold water inner housing having opposing inner and outer ends, the cold water inner housing threadably received within the cold water flow control chamber, a second stem threadably received within the outer end of the cold water inner housing and a check valve received within the inner end of the cold water inner housing;
a hot water port in fluid communication with the hot water intake of the thermostatic valve cartridge;
a cold water port in fluid communication with the cold water intake of the thermostatic valve cartridge, the cold water port axially spaced relative to the hot water port; and
an outlet including an outlet bore in fluid communication with the mixed water outlet of the thermostatic valve cartridge.

12. The valve assembly of claim 11, wherein:
the hot water inlet axis is coaxial with the cold water inlet axis; and
the hot water port and the cold water port are axially spaced apart relative to the longitudinal housing axis.

13. The valve assembly of claim 12, further comprising:
a first connecting passageway having a V-shaped cross-section defined by an inwardly extending portion coupled to the hot water flow chamber, and an outwardly extending portion coupled to the hot water port; and
a second connecting passageway having a V-shaped cross-section defined by an inwardly extending portion coupled to the cold water flow control chamber, and an outwardly extending portion coupled to the cold water port.

14. The valve assembly of claim 11, further comprising:
a first retaining ring supported by the hot water inner housing of the hot water flow control valve and configured to limit movement of the first stem axially outwardly away from the hot water inner housing; and
a second retaining ring supported by the cold water inner housing of the cold water flow control valve and configured to limit movement of the second stem axially outwardly away from the cold water inner housing.

15. The valve assembly of claim 11, further comprising:
a first retaining fastener supported by the hot water outer housing and configured to axially secure the hot water outer housing within the hot water flow control chamber; and
a second retaining fastener supported by the cold water outer housing and configured to axially secure the cold water outer housing within the cold water flow control chamber.

16. The valve assembly of claim 11, further comprising:
a sleeve receiving an upper portion of the valve cartridge and received within the chamber of the valve housing;
a temperature limit stop supported by an outer end of the sleeve; and a resilient clip coupling the temperature limit stop to the sleeve.

17. The valve assembly of claim 16, wherein:
the sleeve includes internal locating flats; and
the valve cartridge includes external locating flats configured to cooperate with the internal locating flats of the sleeve to properly orient the valve cartridge relative to the sleeve.

18. A valve assembly comprising:
a valve housing including a sidewall defining a chamber having a longitudinal housing axis;
a thermostatic valve cartridge received within the chamber, the thermostatic valve cartridge including a hot water intake, a cold water intake, a mixed water outlet, and a thermostatic engine configured to adjust water flow to the mixed water outlet;
a hot water inlet including a hot water inlet bore having a hot water inlet axis;
a cold water inlet including a cold water inlet bore having a cold water inlet axis;
a hot water outer housing defining a hot water flow control chamber fluidly coupled intermediate the hot water inlet and the chamber of the valve housing;
a cold water outer housing defining a cold water flow control chamber fluidly coupled intermediate the cold water inlet and the chamber of the valve housing;
a hot water flow control valve including a hot water inner housing having opposing first and second ends, the hot water inner housing threadably received within the hot water flow control chamber, a first stem threadably received within the first end of the hot water inner housing;
a cold water flow control valve including a cold water inner housing having opposing first and second ends, the cold water inner housing threadably received within the cold water flow control chamber, a second stem threadably received within the first end of the cold water inner housing;
a hot water port in fluid communication with the hot water intake of the thermostatic valve cartridge;
a cold water port in fluid communication with the cold water intake of the thermostatic valve cartridge, the cold water port axially spaced relative to the hot water port;
an outlet including an outlet bore in fluid communication with the chamber of the valve housing;
a sleeve receiving an upper portion of the valve cartridge and is supported by the chamber of the valve housing;
a temperature limit stop supported by an outer end of the sleeve;
a resilient clip coupling the temperature limit stop to the sleeve; and
a cooperating stop configured to rotate with the valve stem and engage with the temperature limit stop to restrict rotation therebetween.

19. The valve assembly of claim 18, wherein:
the temperature limit stop includes an annular body including a plurality of radially inwardly extending teeth; and
the sleeve includes an annular flange surrounding the valve stem and including a plurality of radially outwardly extending teeth configured to cooperate with the teeth of the temperature limit stop to secure the rotational position of the temperature limit stop relative to the sleeve.

20. The valve assembly of claim 19, wherein the flange defines an annular groove to releasably receive the resilient clip.

21. The valve assembly of claim 18, wherein a first protrusion extends axially outwardly from the sleeve, and the temperature limit stop includes a second protrusion extending outwardly from a body, the first protrusion defining a lower limit stop and the second protrusion defining an upper limit stop.

22. The valve assembly of claim 18, wherein:
the hot water flow control valve further comprises a check valve received within the second end of the hot water inner housing; and
the cold water flow control valve further comprises a check valve received within the second end of the cold water inner housing.

23. The valve assembly of claim 18, wherein:
the hot water inlet axis is coaxial with the cold water inlet axis; and
the hot water port and the cold water port are axially spaced apart relative to the longitudinal housing axis.

24. The valve assembly of claim 23, further comprising:
a first connecting passageway including an inwardly extending portion coupled to the hot water flow chamber, and an outwardly extending portion coupled to the hot water port; and
a second connecting passageway includes an inwardly extending portion coupled to the cold water flow control chamber, and an outwardly extending portion coupled to the cold water port.

25. The valve assembly of claim 18, further comprising:
a first retaining ring supported by the hot water inner housing of the hot water flow control valve and configured to limit movement of the first stem axially outwardly away from the hot water inner housing; and
a second retaining ring supported by the cold water inner housing of the cold water flow control valve and configured to limit movement of the second stem axially outwardly away from the cold water inner housing.

26. The valve assembly of claim 18, further comprising:
a first retaining fastener supported by the hot water outer housing and configured to axially secure the hot water outer housing within the hot water flow control chamber; and
a second retaining fastener supported by the cold water outer housing and configured to axially secure the cold water outer housing within the cold water flow control chamber.
